(19) United States
(12) Patent Application Publication
(10) Pub. No.: US 2019/0318400 A1
(43) Pub. Date: Oct. 17, 2019

(54) SYSTEMS AND METHODS FOR MULTI-DIRECTIONAL ELECTRONIC TRANSACTION ARRANGEMENTS

(71) Applicant: eBay Inc., San Jose, CA (US)

(72) Inventor: Alpha Kamchiu Luk, San Jose, CA (US)

(21) Appl. No.: 15/953,662

(22) Filed: Apr. 16, 2018

(51) Int. Cl. G06Q 30/06; G06Q 20/12; G06F 17/30

(52) U.S. Cl. CPC G06Q 30/0611; G06F 17/30333; G06Q 20/12

(57) ABSTRACT

Various embodiments described herein enable a machine to identify electronic transactions involving a multi-directional electronic transaction arrangement on an electronic transaction system, such as an e-commerce website or platform that facilitates an online marketplace. Additionally, some embodiments identify multi-directional electronic transaction arrangements that facilitate multi-directional bartering between two or more e-commerce users, where the bartering may between multiple selling users not in a bartering chain or cycle.

### TECHNICAL FIELD

The present disclosure relates generally to electronic transactions and, more particularly, identifying electronic transactions that involve multi-directional electronic transaction arrangements.

### BACKGROUND

Certain e-commerce platforms permit their users (hereafter, selling users) to offer one or more of their items for purchase by other users (hereafter, referred to buying users). This may be regarded to as customer-to-customer (C2C) sales over an e-commerce platform. Unfortunately, it can be a challenge to find a group of two or more selling users (e.g., a pair of selling users) where each user seller is offering an item that another selling user in the group wants to acquire. This difficulty may be attributed to the rarity of such groups existing.

Though the known techniques based on barter chains/cycles can assist in find group of two or more selling users for bartering or reciprocal purchase arrangements, a barter chain/cycle technique only partially addresses the challenge. A barter chain/cycle technique usually identifies bartering arrangements between two to N number of selling users where each selling user wants the item offered by the preceding user in the chain/cycle and offers an item that the next selling user in the chain/cycle wants. Such bartering purchase arrangements are still rare to find because such bartering purchase arrangements require each item offered/desired in the chain/cycle to be of similar value. Additionally, each selling user may be limited to giving (e.g., by selling) one item and receiving (e.g., by purchasing) one item.

Indeed, the challenges associated with such exchanges in an online environment results in substantial system inefficiencies. An item that would otherwise be bartered may instead remain listed on the network platform until a purchaser willing to pay the full listed price of the item comes along. A system that could more readily identify and facilitate such bartering systems would allow for online listings (and the digital overhead occupied by such listings) to be maintained for a shorter period of time, the disbanding of which would result in less online storage space being consumed. Furthermore, the quicker and more efficient movement of services or goods associated with said product or service ultimately leads to a less cluttered network of online listings, in turn affording remaining buyers and shoppers a cleaner environment to identify desired products—and one that results less searching and sifting through digital records.

Currently, however, because parties amenable to participating in such transactions cannot be easily identified, the traditional listings approach requires persisting an item for sale for larger numbers of website visitors despite the fact that bartering opportunities could lead to a quicker disposition of the item. Accordingly, an improvement that can leverage the online and data-centric nature of today's e-commerce platforms is needed to allow for a more effective web-based operating system that both yields a more efficiently-functioning network while driving a more frictionless commerce experience.

### BRIEF DESCRIPTION OF THE DRAWINGS

Various ones of the appended drawings merely illustrate example embodiments of the present disclosure and cannot be considered as limiting its scope.

FIG. 1 is a network diagram depicting an example client-server system, within which an embodiment may be deployed.

FIG. 2 is a block diagram illustrating an example multi-directional electronic transactions system, in accordance with some embodiments.

FIG. 3 illustrates an example data table used by some embodiments.

FIG. 4 illustrates an example graph in accordance with some embodiments.

FIG. 5 illustrates operation of an example multi-directional electronic transactions system, in accordance with some embodiments.

FIG. 6 illustrates example proposal notifications generated in accordance with some embodiments.

FIG. 7 is a flow diagram illustrating an example method for multi-directional electronic transactions, in accordance with some embodiments.

FIG. 8 is a block diagram illustrating an architecture of software, which can be installed on any one or more of the devices described above.

FIG. 9 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

Various embodiments described herein enable a machine (e.g., a computer system) to identify multiple electronic transactions, according to a multi-directional electronic transaction arrangement, on an electronic transaction system. The electronic transaction system may be one associated with an e-commerce website or platform (hereafter, referred to as an e-commerce system) that facilitates or supports an online marketplace. Additionally, some embodiments identify multi-directional electronic transaction arrangements (also referred to herein as electronic transaction arrangements) that facilitate multi-directional bartering between two or more e-commerce users, where the bartering may between multiple selling users not in a bartering chain or cycle. The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

According to some embodiments, a group of selling users is identified for a bartering transaction arrangement using a data structure, such as a graph. Some such embodiments identify the group of selling users for the bartering transaction arrangement such that a particular selling user in the group can give (e.g., by selling) more than one item to another selling user in the group, or can receive (e.g., by purchasing) more than one item to another selling user in the group, as long as the total value of the items the particular selling user gives is determined to be similar to the total value of the items the particular selling user receives. In this way, some embodiments can reduce the difficulty in identifying a set of bartering transaction arrangements (e.g., transactions) that satisfy the needs of a plurality of selling users. Further, some embodiments use a data structure (e.g., a graph) to identify a group of selling users for a bartering transaction arrangement such that a particular selling user in the group can give or receive currency (e.g., cash, cryptocurrency, etc.) as a substitute when the value of the items given and the value of items received are determined to differ in view of a threshold (e.g., differ significantly according to a threshold). This can further reduce the difficulty in identifying a set of bartering transaction arrangements that satisfy the needs of a plurality of selling users.

Various embodiments improve, or otherwise enable, the ability of a computer system to periodically or persistently execute an algorithm across a large number of users, a large number of desired items, and a large number of offered items (e.g., listed on an e-commerce system for purchase), and identify a set of potential electronic transactions for one or more of those items between two or more of those users, which would not be feasible by human analog (e.g., by hand or by merely thinking). Additionally, various embodiments improve, or otherwise enable, the ability of a computer system to identify potential electronic transactions, for items between users on a system (e.g., an e-commerce system), that would not otherwise by identified in the absence of the embodiments. This can obviate the need for the system to maintain item listings for longer periods, which in turn can reduce the amount of computing resources (e.g., memory, processing, network bandwidth, etc.) needed for maintaining the item listings on the system.

Some embodiments are particularly with respect to customer-to-customer (C2C) electronic transactions on an e-commerce system, where C2C item listings may not be transacted upon (e.g., sold) due to selling users offering items for higher prices than buying users are willing to pay, but where at the same time selling users may desire to acquire certain items. For example, an embodiment may identify and propose an electronic transaction arrangement (e.g., electronic purchase arrangement) involving electronic transactions where a selling user is willing to accept a lower price or value for an item he or she is offering in return for the selling user obtaining an item (from another selling user) he or she desires at a price or value that is less than the asking price by the other selling user.

As used herein, a graph can include a data structure that represents a plurality of vertices or nodes of a graph (e.g., which can represent users) and a set of edges between the vertices/nodes of the graph (e.g., which can represent transactions between the users). The data structure of the graph may comprise a set of ordered pairs of the vertices/nodes for a directed graph having directed edges (e.g., transactions), or a set of unordered pairs of the vertices/nodes for an undirected graph having undirected edges. The data structure of the graph may also comprise an edge value for an edge, which may represent information (e.g., item, item price, etc.) regarding a transaction represented by the edge.

As used herein, an electronic transaction arrangement can include an arrangement for a user (e.g., of an e-commerce system) to purchase an item or sell an item or service by an electronic transaction arranged or proposed with another user (e.g., of the e-commerce system). Additionally, as used herein, a reciprocal electronic transaction arrangement (e.g., reciprocal purchase arrangement) may involve a group of two selling users, and a bartering electronic transaction arrangement (e.g., bartering purchase arrangement) may involve a group of three or more selling users.

Reference will now be made in detail to embodiments of the present disclosure, examples of which are illustrated in the appended drawings. The present disclosure may, however, be embodied in many different forms and should not be construed as being limited to the embodiments set forth herein.

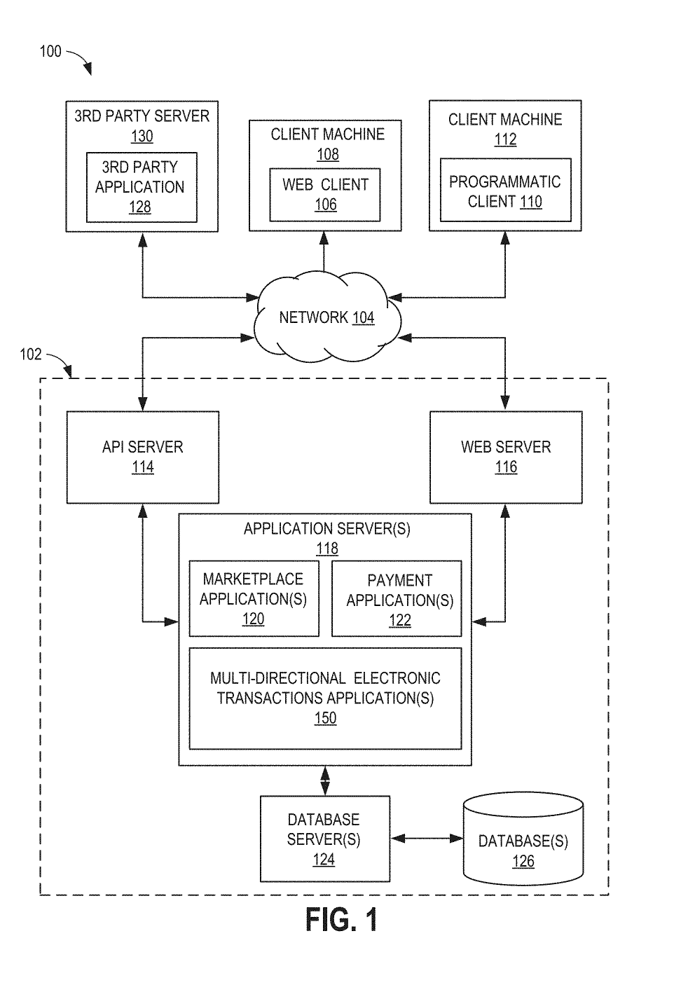

FIG. 1 is a network diagram depicting an example client-server system 100, within which an embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 110 executing on respective client machines 108 and 112.

An application programming interface (API) server 114 and a web server 116 are coupled to, and provide programmatic and web interfaces respectively to, one or more application servers 118. The application servers 118 host one or more marketplace applications 120, payment applications 122, and multi-directional electronic transactions applications 150. The application servers 118 are, in turn, shown to be coupled to one or more database servers 124 that facilitate access to one or more databases 126.

The marketplace applications 120 may provide a number of online marketplace functions and services to users who access the networked system 102, such as searching for items for purchase, posting items for purchase, and facilitating purchase of items (e.g., between two users or between a user and the marketplace provider). The payment applications 122 may provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for product items (e.g., goods or services) that are made available via the marketplace applications 120.

The multi-directional electronic transactions applications 150 may provide functions or services relating to multi-directional electronic transaction functions in accordance with various embodiments described herein, such as identifying multi-directional electronic transaction arrangements between two or more users (e.g., that use the marketplace functions and services of the marketplace applications 120 via one or more client machines). For instance, the multi-directional electronic transactions applications 150 may access a set of items offered (e.g., listed for purchase on an e-commerce system) by users and a set of items desired by the users. At least some portion of the set of desired items may be accessed (e.g., extracted) from one or more items on item wish lists maintained in association with users (e.g., user profiles) on an e-commerce system, such as one being supported by the marketplace applications 120. Similarly, at least some portion of the plurality of offered items may be accessed (e.g., extracted) from offering database maintained by an e-commerce system in association with users (e.g., user profiles), such as one being supported by the marketplace applications 120. Additionally, at least some portion of the set of desired items may be accessed by accessing a list of items deduced or predicted from other data collected about users, such as data regarding a user's item search (e.g., with respect to an Internet search engine), item browsing (e.g., with respect to an e-commerce system), or item purchase history (e.g., with respect to an e-commerce system). The set of desired items and the plurality of offered items are recorded (e.g., inserted) into a data table, such as one maintained within a database. As part of the recording, the data table can include actual or estimated values of items (e.g., offered items, desired items, or both), or can include present status of items (e.g., offered items, desired items, or both). For instance, in the data table, the present status of an item offered by a particular user may be set to “available” whenever that offered item is presently available for proposal in a multi-directional electronic transaction arrangement, or “on hold” or “reserved” anytime that offered item has been listed or used in at least one proposed multi-directional electronic transaction arrangement.

Based on the data table, the multi-directional electronic transactions applications 150 may search for and identify a data structure, such as a graph, that represents a multi-directional electronic transaction arrangement between two or more users that meets a set of criteria. For instance, the data structure identified may represent a multi-directional electronic transaction arrangement where the set of criteria specifies that: each user represented in the data structure (e.g., each node in the graph) will receive one or more their respective desired items (e.g., represented as directional edges) from one or more other users represented in the data structure (e.g., one or more other nodes in the graph); each user represented in the data structure (e.g., each node in the graph) will give one or more their respective offered items (e.g., represented as directional edges) to one or more other users represented in the data structure (e.g., one or more other nodes in the graph); and the total value (e.g., actual or estimated value) of items received by each user is similar (e.g., equal to) the total value (e.g., actual or estimated value) of items given by each user.

Once the data structure is sought for and identified, the multi-directional electronic transactions applications 150 may update the data table to reflect that the offered and desired items involved in the multi-directional electronic transaction arrangement, represented by the identified data structure, are marked as being “on hold” or reserved. The multi-directional electronic transactions applications 150 can cause the multi-directional electronic transaction arrangement to be proposed to at least one of users involved in the multi-directional electronic transaction arrangement, which may involve generating the proposal for the at least one user. The multi-directional electronic transaction arrangement may be proposed by way of a notification via a messaging system (e.g., e-mail, text messaging, instant messaging, etc.), a website (e.g., webpage of an e-commerce website), or some other notification means.

The proposal (e.g., notification of the proposal) generated for a particular user may comprise information, regarding the multi-directional electronic transaction arrangement, specific to the particular user or information regarding all users involved in the multi-directional electronic transaction arrangement. For instance, the proposal for the particular user may include information regarding which one or more offered items the particular user is giving in the multi-directional electronic transaction arrangement (e.g., and specify to which users), and information regarding which one or more desired items is receiving in the multi-directional electronic transaction arrangement (e.g., and specify from which users).

The proposal (e.g., notification of the proposal) may also include a mechanism or means for a user to accept the proposal, a mechanism/means to reject the proposal, or a mechanism/means to accept or reject the proposal for the multi-directional electronic transaction arrangement. The means/mechanism may include, for example, a hyperlink (e.g., to a webpage or web-service) that facilitates acceptance or rejection of the proposal.

The multi-directional electronic transactions applications 150 can receive a set of responses, from the users, to the proposed the multi-directional electronic transaction arrangement. According to some embodiments, in response to determining that each of the users accept the proposed the multi-directional electronic transaction arrangement, the multi-directional electronic transactions applications 150 causes execution of the multi-directional electronic transaction arrangement (e.g., the multiple electronics transactions of the arrangement), and may update the data table to remove, from the data table, one or more records relating to the items involved in the multi-directional electronic transaction arrangement. Alternatively, the data table may be updated such that a given record relating to more than just items involved in the multi-direction electronic transaction arrangement (e.g., record relates to other items not part of the multi-direction electronic transaction arrangement) is updated such that the involved items (e.g., offered items or desired items) are removed from the record while the remainder of the record is preserved.

The data table may be further updated to add records to now reflect that the offered items are now “potentially available” from the one or more users that received based on execution of the multi-directional electronic transaction arrangement. Execution of the multi-directional electronic transaction arrangement may involve the multi-directional electronic transactions applications 150 interfacing/interacting with the marketplace applications 120, the payment applications 122, or both. According to some embodiments, when a multi-directional electronic transaction arrangement is executed, a plurality of electronic transactions associated with the multi-directional electronic transaction arrangement is executed near simultaneously.

According to some embodiments, in response to determining that any of the users reject the proposed the multi-directional electronic transaction arrangement, the multi-directional electronic transactions applications 150 updates the data table to indicate that the items (e.g., offered items) involved in the electronic transaction arrangement are available. Additionally, one or more of the user involved in the proposed multi-directional electronic transaction arrangement may be informed of the proposal being canceled, which may include information regarding the cancellation (e.g., based on rejection of the proposal by one or more users).

While the marketplace, payment, and multi-directional electronic transactions applications 120, 122, and 150 are shown in FIG. 1 to form part of the networked system 102, it will be appreciated that, in some embodiments, any of the applications may form part of a service that is separate and distinct from the networked system 102. For example, for some embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace, payment, and multi-directional electronic transactions applications 120, 122, and 150 could also be implemented as standalone software programs, which do not necessarily have networking capabilities. Further, one or more of the and multi-directional electronic transactions applications 120, 122, and 150 can be implemented as part of the marketplace applications 120.

The web client 106 accesses the various marketplace, payment, and multi-directional electronic transactions applications 120, 122, and 150 via the web interface supported by the web server 116. Similarly, the programmatic client 110 accesses the various services and functions provided by the various marketplace, payment, and multi-directional electronic transactions applications 120, 122, and 150 via the programmatic interface provided by the API server 114. The programmatic client 110 may, for example, be a seller application to enable sellers (e.g., seller users) to author and manage listings on the networked system 102 in an offline manner, and to perform batch-mode communications between the programmatic client 110 and the networked system 102.

FIG. 1 also illustrates a third-party application 128 executing on a third-party server machine 130 as having programmatic access to the networked system 102 via the programmatic interface provided by the API server 114. For example, the third-party application 128 may, utilizing information retrieved from the networked system 102, support one or more features or functions on a website hosted by a third party. The third-party website may, for example, provide one or more promotional, marketplace, payment, multi-directional electronic transaction functions that are supported by the relevant applications of the networked system 102.

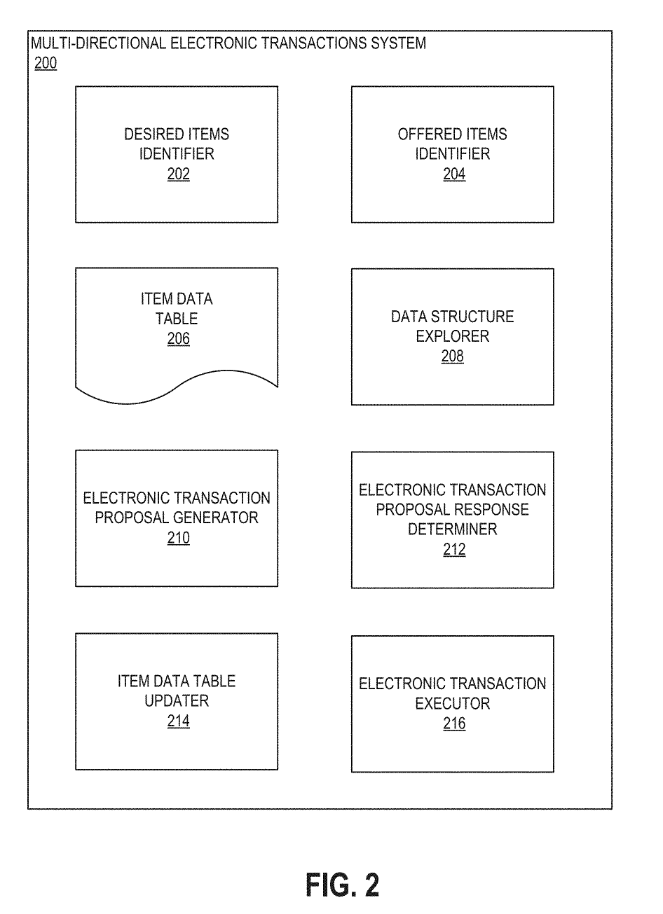

FIG. 2 is a block diagram illustrating an example multi-directional electronic transactions system 200, in accordance with some embodiments. For various embodiments, the components and arrangement of components may vary from what is illustrated in FIG. 2. For instance, the multi-directional electronic transactions system 200 can include more or fewer components than the components shown in the FIG. 2. The various modules of the multi-directional electronic transactions system 200 may be configured to communicate with each other (e.g., via a bus, shared memory, or a switch). Any modules may be implemented using one or more processors 910 (e.g., by configuring such one or more computer processors to perform functions described for that module) and hence may include one or more of the processors 910. As shown in FIG. 2, the multi-directional electronic transactions system 200 comprises a desired items identifier 202, an offered items identifier 204, an item data table 206, a data structure explorer 208, an electronic transaction proposal generator 210, an electronic transaction proposal response determiner 212, an item data table updater 214, and an electronic transaction executor 216.

The desired items identifier 202 may facilitate identification of a plurality of items desired by a plurality of users. For example, the desired items identifier 202 may access a plurality of desired items associated with a plurality of users, where each user in the plurality of users may be associated with at least one desired item in the plurality of desired items. Additionally, the desired items identifier 202 may store a set of records, in the item data table 206, relating to the plurality of desired items accessed by the desired items identifier 202.

The offered items identifier 204 may facilitate identification of a plurality of items offered by a plurality of users (e.g., same plurality of users for which the desired items identifier 202 identifies a plurality of desired items). For example, the offered items identifier 204 may access a plurality of offered items associated with the plurality of users, where each user in the plurality of users may be associated with at least one offered item in the plurality of offered items. Additionally, the offered items identifier 204 may store a set of records, in the item data table 206, relating to the plurality of offered items accessed by the offered items identifier 204.

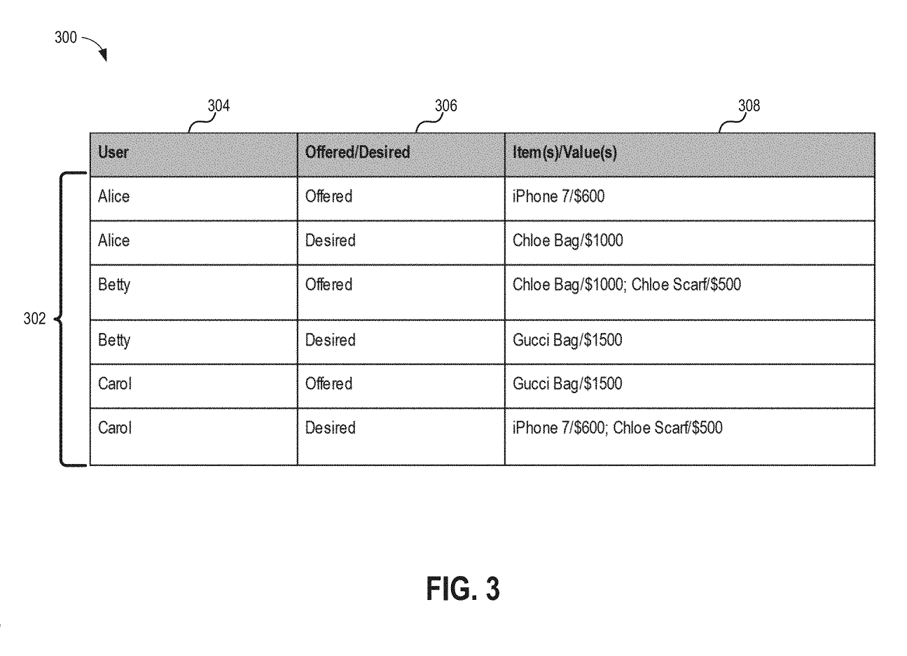

The item data table 206 may facilitate storage (e.g., addition or insertion) of records, in a data table, relating to one or more items that may be included in an electronic transaction arrangement proposed by an embodiment. Depending on the embodiment, the data table (e.g., the item data table 206) used to store records relating to the set of desired items may be the same data table (e.g., the item data table 206) used to store records relating to the plurality of offered items. For some embodiments, the item data table 206 may be similar to an example data table illustrated and described herein with respect to FIG. 3.

The data structure explorer 208 may facilitate searching for a data structure (e.g., graph), representing an electronic transaction arrangement between two or more users, based on the item data table 206. According to various embodiments, the data structure explorer 208 searches for a data structure that represents an electronic transaction arrangement, between two or more users, where each of the two or more users is represented by a node in the data structure. Additionally, the data structure represents an electronic transaction arrangement where each node (representing a user): receives one or more desired items in the plurality of desired items from one or more other nodes in the data structure; and gives one or more offered items in the plurality of offered items to one or more other nodes in the data structure, such that a difference between a first estimated value of the one or more desired items and a second estimated value of the one or more offered items is less than a difference threshold. The difference threshold may be based on or set according to a user preference (e.g., individual user preferences stored in a user profile), may be based on or set according to a general system preference, or some combination thereof.

The electronic transaction proposal generator 210 may facilitate proposing the electronic transaction arrangement to at least one user involved in the electronic transaction arrangement. The electronic transaction arrangement may be proposed in response to the data structure explorer 208 searching for and identifying the data structure. The electronic transaction proposal generator 210 may generate a set of proposals, based on the electronic transaction arrangement, for the two or more users involved in the electronic transaction arrangement, and send the set of proposals to the two or more users. Additionally, the electronic transaction proposal generator 210 may update (or cause to update via the item data table updater 214) the data table 206 to indicate that items involved in the electronic transaction arrangement are “on hold” or “reserved.” Such items may be marked as “available” in the data table 206 prior to the update.

The electronic transaction proposal response determiner 212 may facilitate determining a user response to the electronic transaction arrangement proposed by the electronic transaction proposal generator 210. For some embodiments, determining the user response comprises determining whether any user in the two or more users rejects a proposal (received via the system 200) from the set of proposals. Additionally, for some embodiments, determining the user response comprises determining whether each of the two or more users accepts the set of proposals.

The item data table updater 214 may facilitate updating one or more records existing in the item data table 206. For some embodiments, based on the electronic transaction proposal response determiner 212 determining that at least one user (involved in the electronic transaction arrangement proposed by the electronic transaction proposal generator 210) rejects the proposed electronic transaction arrangement, item data table updater 214 updates the data table (operated on by the item data table 206) to indicate that the items involved in the electronic transaction arrangement are available. Additionally, for some embodiments, based on the electronic transaction proposal response determiner 212 determining that each of the users (involved in the electronic transaction arrangement proposed by the electronic transaction proposal generator 210) accepts the proposed electronic transaction arrangement, the data table is updated to remove, from the data table, one or more records relating to the items involved in the proposed electronic transaction arrangement. Alternatively, the item data table updater 214 may update the item data table 206 such that a given record relating to more than just items involved in the multi-direction electronic transaction arrangement is updated such that the involved items are removed from the record while the remainder of the record is preserved.

The electronic transaction executor 216 may facilitate (e.g., cause) execution of the electronic transaction arrangement proposed by the electronic transaction proposal generator 210. According to some embodiments, based on the electronic transaction proposal response determiner 212 determining that each of the users (involved in the electronic transaction arrangement proposed by the electronic transaction proposal generator 210) accepts the proposed electronic transaction arrangement, the electronic transaction executor 216 executing the proposed electronic transaction arrangement.

FIG. 3 illustrates an example data table 300 used by some embodiments. As illustrated, the data table 300 includes records 302 relating to items that may be in an electronic transaction arrangement proposed by some embodiments described herein. For example, the item data table 206 (of the multi-directional electronic transactions system 200) may comprise the data table 300 and operated on by the multi-directional electronic transactions system 200. Additionally, the data table 300 includes a column 304 indicating a user associated with each of the records 302, a column 306 indicating whether each of the records 302 is related to offered items or desired items, and a column 308 indicating items and their associated values (e.g., estimated or actual values) for each of the records 302. The data table 300 includes records 302 for users “Alice,” “Betty,” and “Carol,” which indicate that: “Alice” is offering an IPHONE 7 for a value of $600; “Alice” desires a CHLOE bag, which has a value (e.g., estimated or market value) of $1000; “Betty” is offering an CHLOE bag for a value of $1000 and a CHLOE scarf for a value of $500; “Betty” desires a GUCCI Bag, which has a value (e.g., estimated or market value) of $1500; “Carol” is offering an GUCCI bag for a value of $1500; and “Carol” desires a IPHONE 7, which has a value (e.g., estimated or market value) of $600, and a CHLOE scarf, which has a value (e.g., estimated or market value) of $500.

According to some embodiments, the data structure explorer 208 (of the multi-directional electronic transactions system 200) searches for a data structure (e.g., graph) representing an electronic transaction arrangement between two or more users based on the data table 300. As noted herein, each of the two or more users may be represented by a node in the data structure, and the data structure identified may represents an electronic transaction arrangement where each node: receives one or more desired items in the plurality of desired items from one or more other nodes in the data structure; and gives one or more offered items in the plurality of offered items to one or more other nodes in the data structure, such that a difference between a first estimated value of the one or more desired items and a second estimated value of the one or more offered items is less than a difference threshold. The difference threshold may be based on or set according to a user preference (e.g., individual user preferences stored in a user profile), may be based on or set according to a general system preference, or some combination thereof.

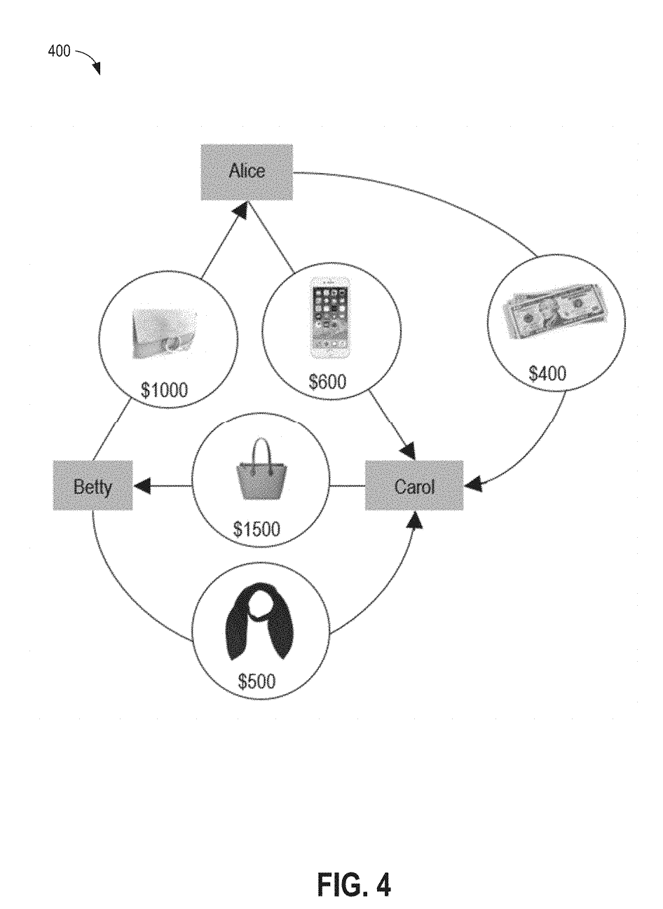

FIG. 4 illustrates an example graph 400 in accordance with some embodiments. According to some embodiments, the graph 400 is one identified by the data structure explorer 208 (of the multi-directional electronic transactions system 200) based the data table 300 illustrated by FIG. 3. According to an electronic transaction arrangement proposed based on the graph 400: “Alice” can receive from “Betty” a CHLOE bag having a value of $1000, and give “Carol” an IPHONE 7 having a value of $600 and $400 in cash; “Betty” can receive from “Carol” a GUCCI bag having a value of $1500, give “Carol” a CHLOE scarf having a value of $500, and give “Alice” a CHLOE bag having a value of $1000; and “Carol” can receive from “Alice” an IPHONE 7 having a value of $600 and $400 in cash, receive from “Betty” a CHLOE scarf having a value of $500, and give “Betty” a GUCCI bag having a value of $1500.

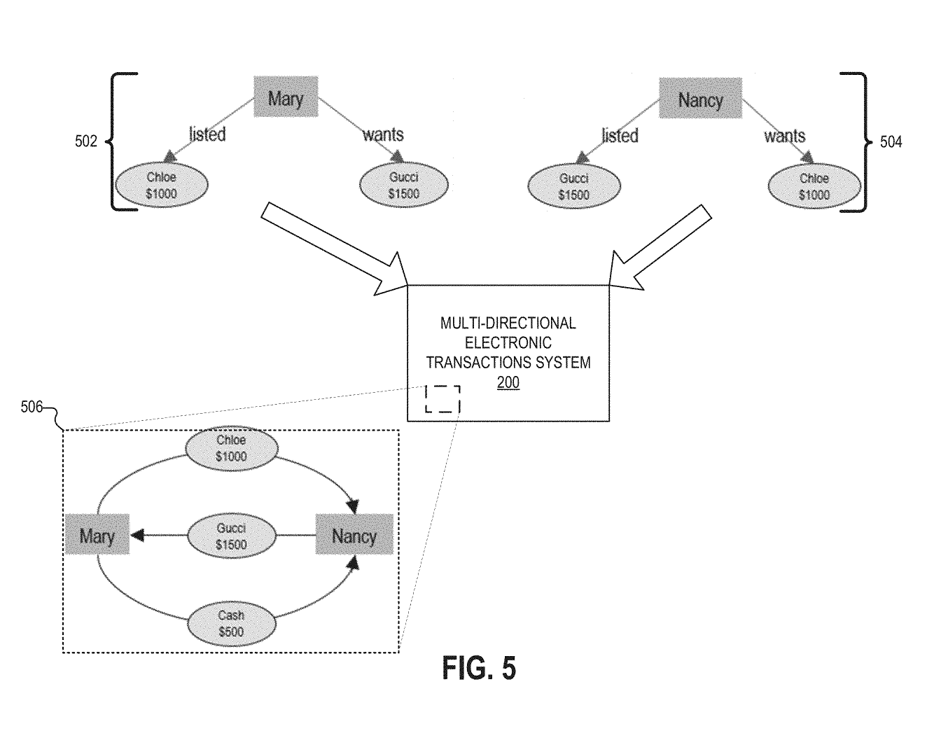

FIG. 5 illustrates operation of the multi-directional electronic transactions system 200, in accordance with some embodiments. As illustrated by diagram 502, a user “Mary” is offering (e.g., has listed) a CHLOE bag for $1000 (e.g., on an e-commerce system), and desires (e.g., wants) a GUCCI bag having a value (e.g., market or estimated value) of $1500. As illustrated by diagram 504, a user “Nancy” is offering (e.g., has listed) a GUCCI bag for $1500 (e.g., on an e-commerce system), and desires (e.g., wants) a CHLOE bag having a value (e.g., market or estimated value) of $1000. According to some embodiments, the multi-directional electronic transactions system 200 accesses stored data (e.g., stored on an e-commerce system) that represents information illustrated by the diagrams 502 and 504 and, during operation, identifies a graph 506 that represents an electronic transaction arrangement (e.g., a multi-directional, reciprocal electronic transaction arrangement) that can be proposed by the multi-directional electronic transactions system 200 to “Mary” and “Nancy.”

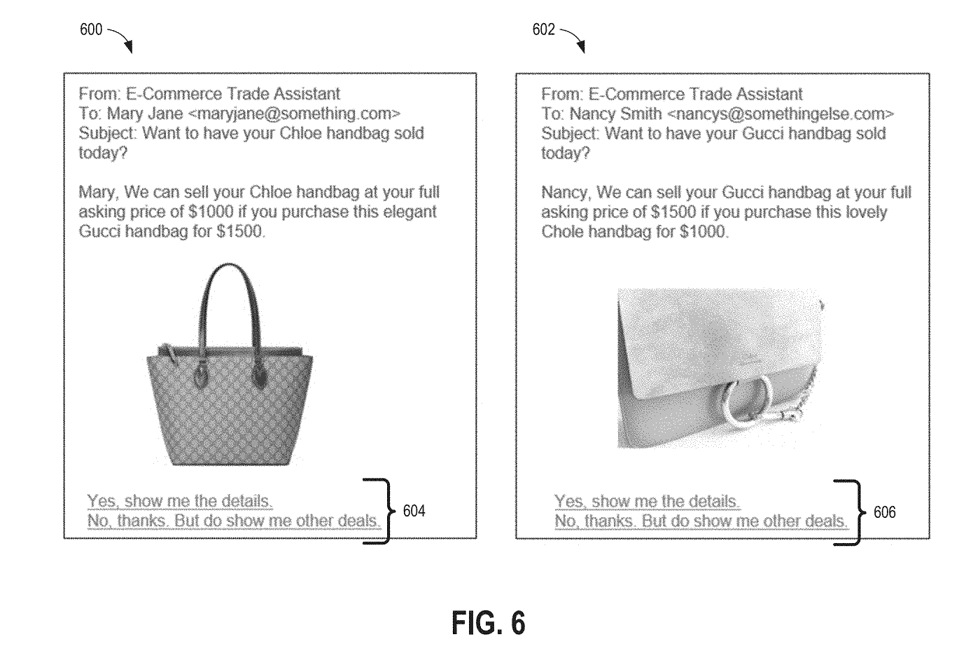

FIG. 6 illustrates example proposal notifications 600, 602 generated in accordance with some embodiments. According to some embodiments, the electronic transaction proposal generator 210 (of the multi-directional electronic transactions system 200) generates a notification similar to the proposal notifications 600, 602. As illustrated, the proposal notifications 600, 602 represent proposal notifications sent to users via e-mail.

The proposal notification 600 is generated for a user “Mary” that is associated with the e-mail address “maryjane@something.com.” The proposal notification 600 proposes at least a portion of an electronic transaction arrangement (e.g., proposed by the multi-directional electronic transaction system 200) where Mary electronically sells their offered item of a CHLOE handbag at Mary's full asking price ($1000) to another user in exchange for Mary electronically purchasing their desired item of a GUCCI handbag for $1500 from another user, who may or may not be the same user to whom who Mary will electronically sell the CHLOE handbag under the electronic transaction arrangement. The proposal notification 600 includes an image of the GUCCI handbag Mary would purchase under the electronic transaction arrangement. The proposal notification 600 also includes a means or mechanism 604 (e.g., hyperlinks) that permit Mary to either accept or reject the proposal presented by the notification 600.

The proposal notification 602 is generated for a user “Nancy” that is associated with the e-mail address “nancys@somethingelse.com.” The proposal notification 602 proposes at least a portion of the electronic transaction arrangement (e.g., proposed by the multi-directional electronic transaction system 200) where Nancy electronically sells their offered item of a GUCCI handbag at Nancy's full asking price ($1500) to another user in exchange for Nancy electronically purchasing their desired item of a CHLOE handbag for $1000 from another user, who may or may not be the same user to whom who Nancy will electronically sell the GUCCI handbag under the electronic transaction arrangement. The proposal notification 602 includes an image of the CHLOE handbag Nancy would purchase under the electronic transaction arrangement. The proposal notification 600 also includes a means or mechanism 606 (e.g., hyperlinks) that permit Nancy to either accept or reject the proposal presented by the notification 602.

As illustrated, each of the proposal notifications 600, 602 only discloses the portion of the electronic transaction arrangement as it relates to the user receiving the notification and excludes full details of the electronic transaction arrangement. For some embodiments, a proposal notification can include more information regarding the electronic transaction arrangement than shown in FIG. 6. For instance, the proposal notifications 600 to Mary could indicate who Mary is transacting with (e.g., to whom Mary is electronically selling the CHLOE handbag, or from whom Mary is electronically purchasing the GUCCI handbag).

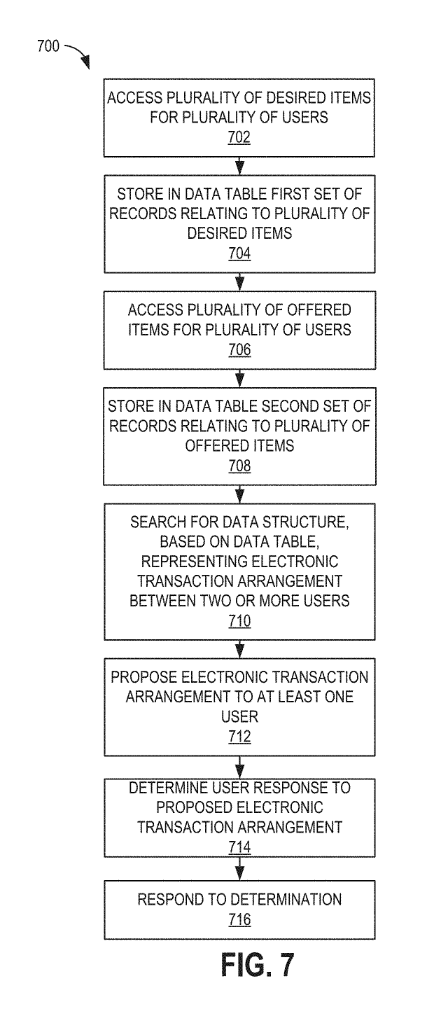

FIG. 7 is a flow diagram illustrating an example method 700 for multi-directional electronic transactions, in accordance with some embodiments. It will be understood that example methods described herein may be performed by a machine, in accordance with some embodiments. For example, the method 700 may be performed by the multi-directional electronic transactions system 200. An operation of various methods described herein may be performed by a processor (e.g., a central processing unit or graphics processing unit) of a machine (e.g., a desktop, server, laptop, mobile phone, tablet, or other computing device), which may be part of a computing system based on a cloud architecture. Example methods described herein may also be implemented in the form of executable instructions stored on a machine-readable medium or in the form of electronic circuitry. For instance, the operations of a method 700 of FIG. 7 may be represented by executable instructions that, when executed by a processor of a machine, cause the machine to perform the method 700. Depending on the embodiment, an operation of an example method described herein may be repeated in different ways or involve intervening operations not shown. Although the operations of example methods may be depicted and described in a certain order, the order in which the operations are performed may vary among embodiments, including performing certain operations in parallel.

Referring now to the FIG. 7, as shown, the method 700 begins with operation 702 (e.g., by the desired items identifier 202) accessing a plurality of desired items associated with a plurality of users, where each user in the plurality of users may be associated with at least one desired item in the plurality of desired items. An item desired by a user may be one included on a wish list associated with the user (e.g., an e-commerce system, such as one support an online marketplace), which can be accessed during operation 702. Additionally, an item desired by a user may be one included indicated or noted in the user's search history (e.g., Internet search engine queries or search queries on an e-commerce system) or browsing history (e.g., website browser history or history of item browsing on an e-commerce system), which can be accessed during operation 702.

The method 700 continues with operation 704 (e.g., by the desired items identifier 202) storing, in a data table (e.g., the item data table 206), a first set of records relating to the set of desired items. The items offered by a user may be ones listed in association with the user on an e-commerce system, which may support an online marketplace. The method 700 continues with operation 706 (e.g., by the offered items identifier 204) accessing a plurality of offered items associated with the plurality of users, where each user in the plurality of users may be associated with at least one offered item in the plurality of offered items. The method 700 continues with operation 708 (e.g., by the offered items identifier 204) storing, in the data table (e.g., the item data table 206), a second set of records relating to the plurality of offered items.

The method 700 continues with operation 710 (e.g., by the data structure explorer 208) searching for a data structure based on the data table (e.g., the item data table 206) as updated by operations 704 and 708, where the data structure represents an electronic transaction arrangement between two or more users in the plurality of users, and each of the two or more users is represented by a node in the data structure. According to some embodiments, the data structure comprises a graph. The electronic transaction arrangement may be one where, for example, a first user provides at least one offered item (e.g., item listed by the first user) to a second user and the first user receives at least one desired item (desired by the first user) from the the second user. Additionally, the electronic transaction arrangement may be one where, for example, a first user provides at least one offered item (e.g., item listed by the first user) to a second user and the first user receives at least one desired item (desired by the first user) from a third user different from the second user.

Additionally, according to some embodiments, each of the two or more users is represented by a node in the data structure, and the data structure searched for by operation 710 represents one representing an electronic transaction arrangement where each node: receives one or more desired items in the plurality of desired items from one or more other nodes in the data structure; and gives one or more offered items in the plurality of offered items to one or more other nodes in the data structure, such that a difference between a first estimated value of the one or more desired items and a second estimated value of the one or more offered items is less than a difference threshold. The difference threshold may be based on or set according to a user preference (e.g., individual user preferences stored in a user profile), may be based on or set according to a general system preference, or some combination thereof.

The method 700 continues with operation 712 (e.g., by the electronic transaction proposal generator 210) proposing the electronic transaction arrangement to at least one user of the two or more users in response to finding the data structure at operation 710. For some embodiments, proposing the electronic transaction arrangement during operation 710 comprises generating, based on the electronic transaction arrangement, a set of proposals for two or more users associated involved in the electronic transaction arrangement being proposed and sending (e.g., via electronic communications, such as e-mail) at least one proposal from the generated set to at least one of the two or more users. For some embodiments, the generated set of proposal may be sent near simultaneously to all the users involved in the electronic transaction arrangement being proposed. Additionally, for some embodiments, the proposals in the generated set may be sent in a particular order. For instance, initial only one proposal may be sent out to a first user and, subsequent to an acceptance by the first user, another proposal from the generated set may be sent out to another user, and so on. In another example, proposals may be initially sent to those one or more users offering items at above-market asking prices. For some embodiments, proposing the electronic transaction arrangement during operation 710 also comprises updating the data table (e.g., the item data table 206) to indicate that items involved in the electronic transaction arrangement being proposed are “on hold” or “reserved.” Such items may be marked as “available” in the data table prior to the update by operation 712. According to some embodiments, the electronic transaction arrangement is proposed to some or all of the users involved in the electronic transaction arrangement in response to the at least one of those users offering a particular item for purchase on an e-commerce system (e.g., supporting an online marketplace system) at an above-market asking price.

The method 700 continues with operation 714 (e.g., by the electronic transaction proposal response determiner 212) determining a user response to the electronic transaction arrangement proposed at operation 712. For some embodiments, determining the user response comprises determining whether any user in the two or more users rejects a proposal (via operation 712) from the set of proposals. Additionally, for some embodiments, determining the user response comprises determining whether each of the two or more users accepts the set of proposals.

The method 700 continues with operation 716 (e.g., by the electronic transaction proposal response determiner 212) responding to the determination of operation 714. For some embodiments, in response to determining that at least one in the two or more users rejects the proposal from the set of proposals, the data table of operations 704 and 708 (e.g., the item data table 206) is updated (e.g., by the item data table updater 214) to indicate that the items involved in the electronic transaction arrangement are available. Additionally, for some embodiments, in response to determining that each of the two or more users accepts the set of proposals, the electronic transaction arrangement is executed (e.g., by the electronic transaction executor 216) and the data table (e.g., the item data table 206) is updated (e.g., by the item data table updater 214) to remove, from the data table, one or more records relating to the items involved in the electronic transaction arrangement. Alternatively, the data table may be updated such that a given record relating to more than just items involved in the multi-direction electronic transaction arrangement is updated such that the involved items are removed from the record while the remainder of the record is preserved.

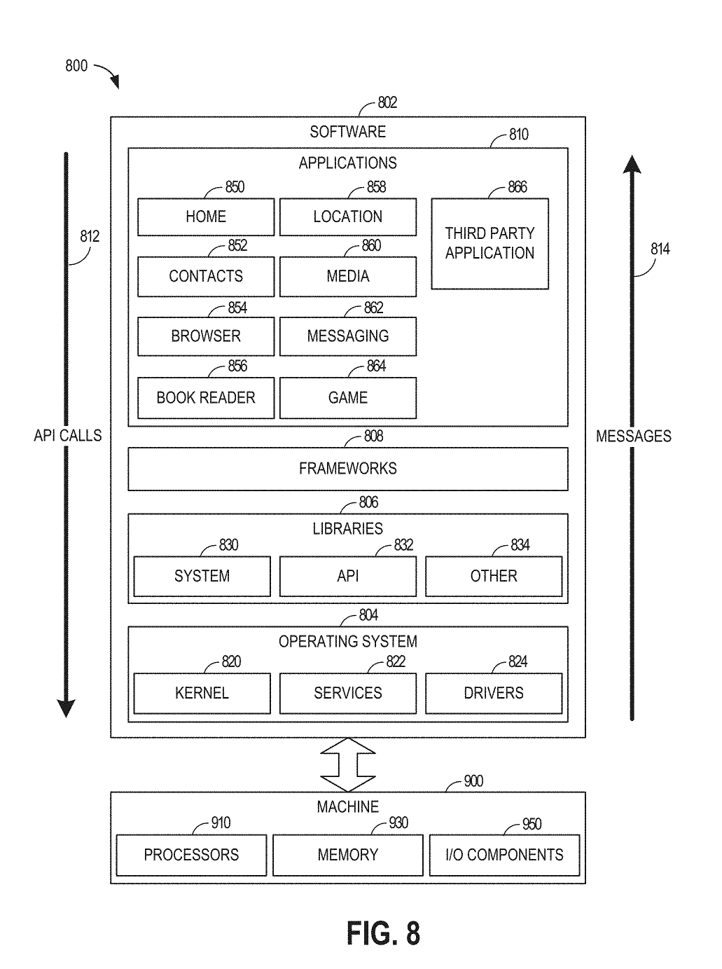

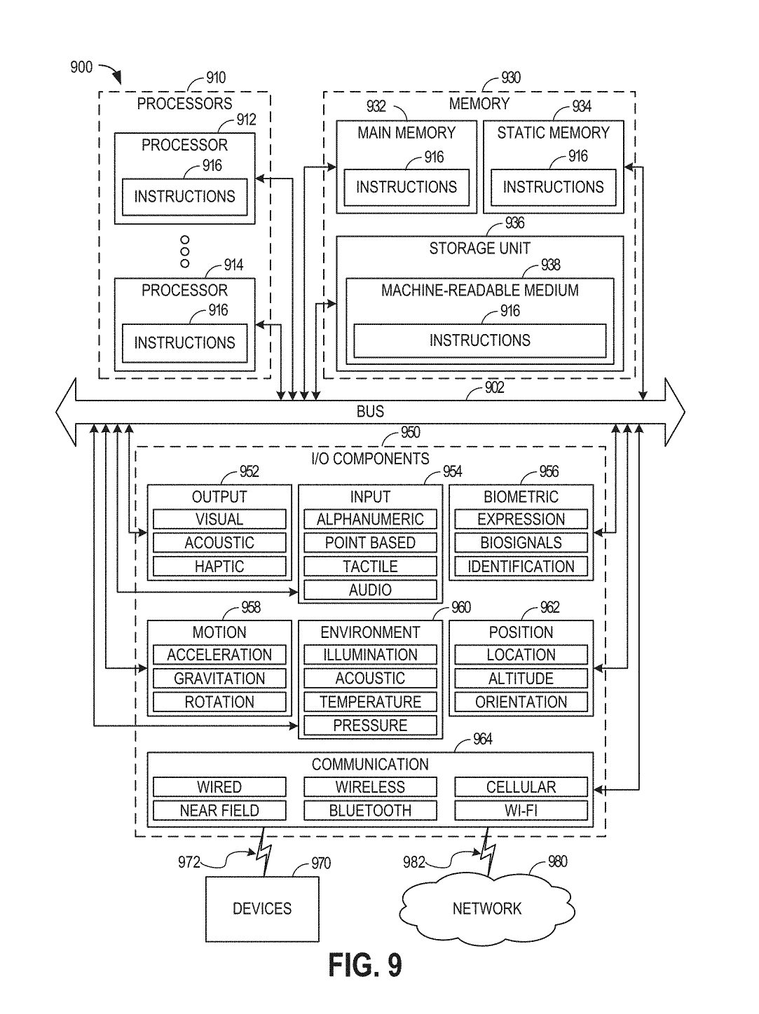

FIG. 8 is a block diagram 800 illustrating an architecture of software 802, which can be installed on any one or more of the devices described above. FIG. 8 is merely a non-limiting example of a software architecture, and it will be appreciated that many other architectures can be implemented to facilitate the functionality described herein. In various embodiments, the software 802 is implemented by hardware such as a machine 900 of FIG. 9 that includes processors 910, memory 930, and input/output (I/O) components 950. In this example architecture, the software 802 can be conceptualized as a stack of layers where each layer may provide a particular functionality. For example, the software 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various graphic user interface (GUI) functions, high-level resource management, high-level location services, and so forth. The frameworks 808 can provide a broad spectrum of other APIs that can be utilized by the applications 810, some of which may be specific to a particular operating system or platform.

In an example embodiment, the applications 810 include a home application 850, a contacts application 852, a browser application 854, a book reader application 856, a location application 858, a media application 860, a messaging application 862, a game application 864, and a broad assortment of other applications such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 9 illustrates a diagrammatic representation of a machine 900 in the form of a computer system within which a set of instructions may be executed for causing the machine to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the method 700 of FIG. 7. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an application-specific integrated circuit (ASIC), a Radio-Frequency Integrated Circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936 including a machine-readable medium 938, each accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various example embodiments, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 930, 932, 934, and/or memory of the processor(s) 910) and/or the storage unit 936 may store one or more sets of instructions and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 980 may be an ad hoc network, an intranet, an extranet, a virtual private network (VPN), a local-area network (LAN), a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium.” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Throughout this specification, plural instances may implement resources, components, operations, or structures described as a single instance. Although individual operations of one or more methods are illustrated and described as separate operations, one or more of the human individual operations may be performed concurrently, and nothing requires that the operations be performed in the order illustrated.

As used herein, modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various embodiments, one or more computer systems or one or more hardware modules thereof may be configured by software (e.g., an application or portion thereof) as a hardware module that operates to perform operations described herein for that module.

In some embodiments, a hardware module may be implemented electronically. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over suitable circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

As used herein, the term “or” may be construed in either an inclusive or exclusive sense. The terms “a” or “an” should be read as meaning “at least one,” “one or more” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate components in example configurations may be implemented as a combined structure or component. Similarly, structures and functionality presented as a single component may be implemented as separate components. The specification and drawings are, accordingly, to be regarded in an illustrative rather than a restrictive sense.

Boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
accessing, by one or more processors, a plurality of desired items associated with a plurality of users, each user in the plurality of users being associated with at least one desired item in the plurality of desired items;
storing, by the one or more processors in a data table, a first set of records relating to the plurality of desired items;
accessing, by one or more processors, a plurality of offered items associated with the plurality of users, each user in the plurality of users being associated with at least one offered item in the plurality of offered items;
storing, by the one or more processors in the data table, a second set of records relating to the plurality of offered items;
searching, by the one or more processors, for a data structure based on the data table, the data structure representing an electronic transaction arrangement between two or more users in the plurality of users, each of the two or more users being represented by a node in the data structure, and each node of the data structure:
receiving one or more desired items in the plurality of desired items from one or more other nodes in the data structure; and
giving one or more offered items in the plurality of offered items to one or more other nodes in the data structure, such that a difference between a first estimated value of the one or more desired items and a second estimated value of the one or more offered items is less than a difference threshold; and
in response to finding the data structure, proposing, by the one or more processors, the electronic transaction arrangement to at least one user of the two or more users by generating, based on the electronic transaction arrangement, a set of proposals for the two or more users and sending the set of proposals to the two or more users, and by updating the data table to indicate that items involved in the electronic transaction arrangement are on hold.

2. The method of claim 1, further comprising:
determining, by the one or more processors, whether any user in the two or more users rejects a proposal from the set of proposals; and
in response to determining that at least one in the two or more users rejects the proposal from the set of proposals, updating, by the one or more processors, the data table to indicate that the items involved in the electronic transaction arrangement are available.

3. The method of claim 1, further comprising:
determining, by the one or more processors, whether each of the two or more users accepts the set of proposals; and
in response to determining that each of the two or more users accepts the set of proposals:
executing, by the one or more processors, the electronic transaction arrangement; and
updating, by the one or more processors, the data table to remove, from the data table, one or more records relating to the items involved in the electronic transaction arrangement.

4. The method of claim 1, wherein the data structure comprises a graph.

5. The method of claim 1, wherein the two or more users including a first user, a second user, and a third user, and the electronic transaction arrangement comprises the first user providing at least one offered item to the second user and the first user receiving at least one desired item from the third user.

6. The method of claim 1, wherein the plurality of desired items includes at least one particular item associated with a particular user from the plurality of users, the at least one particular item being provided from an item wish list associated with the particular user, and the item wish list being on an online marketplace system.

7. The method of claim 1, wherein the plurality of desired items includes at least one particular desired item associated with a particular user from the plurality of users, the at least one particular item being associated with at least one of a search query entered by the particular user or a website browsing history of the particular user.

8. The method of claim 1, wherein the proposing the electronic transaction arrangement to the at least one user is further in response to the at least one user offering a particular item for purchase on an online marketplace system at an above-market asking price.

9. A system comprising:
one or more processors; and
a computer-readable medium having instructions stored there on, which, when executed by the one or more processors, cause the system to perform the operations of:
accessing a plurality of desired items associated with a plurality of users, each user in the plurality of users being associated with at least one desired item in the plurality of desired items;
storing, in a data table, a first set of records relating to the plurality of desired items;
accessing a plurality of offered items associated with the plurality of users, each user in the plurality of users being associated with at least one offered item in the plurality of offered items;
storing, in the data table, a second set of records relating to the plurality of offered items;
searching for a data structure based on the data table, the data structure representing an electronic transaction arrangement between two or more users in the plurality of users, each of the two or more users being represented by a node in the data structure, and each node of the data structure:
receiving one or more desired items in the plurality of desired items from one or more other nodes in the data structure; and
giving one or more offered items in the plurality of offered items to one or more other nodes in the data structure, such that a difference between a first estimated value of the one or more desired items and a second estimated value of the one or more offered items is less than a difference threshold; and
in response to finding the data structure, proposing the electronic transaction arrangement to at least one user of the two or more users by generating, based on the electronic transaction arrangement, a set of proposals for the two or more users and sending the set of proposals to the two or more users, and by updating the data table to indicate that items involved in the electronic transaction arrangement are on hold.

10. The system of claim 9, wherein the operations further comprise:
determining whether any user in the two or more users rejects a proposal from the set of proposals; and
in response to determining that at least one in the two or more users rejects the proposal from the set of proposals, updating the data table to indicate that the items involved in the electronic transaction arrangement are available.

11. The system of claim 9, wherein the operations further comprise:
determining whether each of the two or more users accepts the set of proposals; and
in response to determining that each of the two or more users accepts the set of proposals:
executing the electronic transaction arrangement; and
updating the data table to remove, from the data table, one or more records relating to the items involved in the electronic transaction arrangement.

12. The system of claim 9, wherein the data structure comprises a graph.

13. The system of claim 9, wherein the two or more users including a first user, a second user, and a third user, and the electronic transaction arrangement comprises the first user providing at least one offered item to the second user and the first user receiving at least one desired item from the third user.

14. The system of claim 9, wherein the plurality of desired items includes at least one particular item associated with a particular user from the plurality of users, the at least one particular item being provided from an item wish list associated with the particular user, and the item wish list being on an online marketplace system.

15. The system of claim 9, wherein the plurality of desired items includes at least one particular desired item associated with a particular user from the plurality of users, the at least one particular item being associated with at least one of a search query entered by the particular user or a website browsing history of the particular user.

16. The system of claim 9, wherein the proposing the electronic transaction arrangement to the at least one user is further in response to the at least one user offering a particular item for purchase on an online marketplace system at an above-market asking price.

17. A non-transitory computer-readable storage medium comprising instructions that, when executed by at least one processor of a machine, cause the machine to perform operations comprising:
accessing a plurality of desired items associated with a plurality of users, each user in the plurality of users being associated with at least one desired item in the plurality of desired items;
storing, in a data table, a first set of records relating to the plurality of desired items;
accessing a plurality of offered items associated with the plurality of users, each user in the plurality of users being associated with at least one offered item in the plurality of offered items;
storing, in the data table, a second set of records relating to the plurality of offered items;
searching for a data structure based on the data table, the data structure representing an electronic transaction arrangement between two or more users in the plurality of users, each of the two or more users being represented by a node in the data structure, and each node of the data structure:
receiving one or more desired items in the plurality of desired items from one or more other nodes in the data structure; and
giving one or more offered items in the plurality of offered items to one or more other nodes in the data structure, such that a difference between a first estimated value of the one or more desired items and a second estimated value of the one or more offered items is less than a difference threshold; and
in response to finding the data structure, proposing the electronic transaction arrangement to at least one user of the two or more users by generating, based on the electronic transaction arrangement, a set of proposals for the two or more users and sending the set of proposals to the two or more users, and by updating the data table to indicate that items involved in the electronic transaction arrangement are on hold.

18. The non-transitory computer-readable storage medium of claim 17, wherein the operations further comprise:
determining whether any user in the two or more users rejects a proposal from the set of proposals; and
in response to determining that at least one in the two or more users rejects the proposal from the set of proposals, updating the data table to indicate that the items involved in the electronic transaction arrangement are available.

19. The non-transitory computer-readable storage medium of claim 17, wherein the operations further comprise:
determining whether each of the two or more users accepts the set of proposals; and
in response to determining that each of the two or more users accepts the set of proposals:
executing the electronic transaction arrangement; and
updating the data table to remove, from the data table, one or more records relating to the items involved in the electronic transaction arrangement.

20. The non-transitory computer-readable storage medium of claim 17, wherein the data structure comprises a graph.
